(19) United States
(12) Patent Application Publication
(10) Pub. No.: US 2010/0148734 A1
(43) Pub. Date: Jun. 17, 2010

(54) Apparatus for compnsating output voltage

(76) Inventor: Jack Zhiang, Shulin City (TW)

Correspondence Address: Flash Intellectual Property, Inc.;Attn. Cheng-Ju Chiang, P.O. Box 766, Chino, CA, 91708, US

(21) Appl. No.: 12/314,461

(22) Filed: Dec. 11, 2008

(51) Int. Cl. H02M 5/257

(52) U.S. Cl. 323/234

(57) ABSTRACT

An apparatus for compensating output voltage includes a DC-DC conversion IC, a step-up/down transforming circuit, a current detection resistor and a voltage feedback point, wherein in the step-up/down transforming circuit, the current detection resistor is connected in series to a ground end of the DC-DC conversion IC, and voltage drop is produced as supplying current flows through the current detection resistor, thereby utilizing the voltage drop to step up a reference voltage within the DC-DC conversion IC so that the DC-DC conversion IC can regulate output voltage of the step-up/down transforming circuit for a purpose of voltage compensation.

### BACKGROUND OF THE INVENTION

1. Field of the Invention

The present invention relates to an apparatus for compensating output voltage used in a DC to DC converter which is able to compensate the loss of voltage resulting from wire impedance and contact impedance of connectors and to output an appropriate and a constant voltage as request.

2. Related Art

Portable electronic products are rapidly developed and produced in recent years such as car chargers that tend to be designed with higher output voltage in order to be used for various electronic products. As a result, voltage drop is to be increased easily and which causes voltage regulate rate is over an acceptable range in most electronic products. To overcome such drawbacks, conventional linear regulators are developed, however, the conventional linear regulators are very inefficient if the voltage drop is large and the current high.

### SUMMARY OF THE INVENTION

Accordingly, an object of the present invention is to provide an apparatus for compensating output voltage, which is efficient in compensating the voltage drop and providing constant output voltage.

To achieve the above-mentioned object, the apparatus for compensating output voltage includes a DC-DC conversion IC, a step-up/down transforming circuit, a current detection resistor and a voltage feedback point, wherein in the step-up/down transforming circuit, the current detection resistor is connected in series to a ground end of the DC-DC conversion IC, and voltage drop is produced as supplying current flows through the current detection resistor, thereby utilizing the voltage drop to step up a reference voltage within the DC-DC conversion IC so that the DC-DC conversion IC can regulate output voltage of the step-up/down transforming circuit for a purpose of voltage compensation.

According to the above-mentioned features of the apparatus, the DC-DC conversion IC can be selected from regular marketing products having similar functions, such as model MC34063.

### BRIEF DESCRIPTION OF THE DRAWINGS

FIG. 1 is a first embodiment illustrating a step-up transforming circuit in which an apparatus for compensating output voltage of the present invention is applied with a DC-DC conversion IC of model MC34063;

FIG. 2 is a second embodiment illustrating a step-down transforming circuit in which the apparatus of the present invention is applied with the DC-DC conversion IC of model MC34063; and

FIG. 3 is a circuit diagram showing an internal circuit of the DC-DC conversion IC of model MC34063.

### DESCRIPTION OF THE PREFERRED EMBODIMENTS

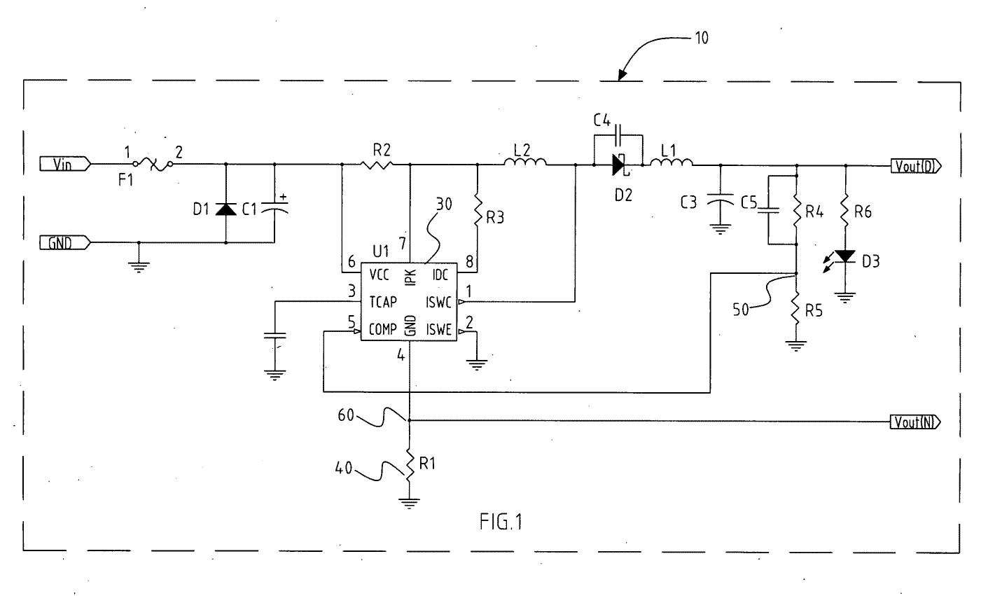

Referring to FIG. 1 illustrating a first embodiment in which an apparatus for compensating output voltage of the present invention is applied in a step-up transforming circuit 10, the apparatus including a DC-DC conversion IC 30, the step-up transforming circuit 10, a current detection resistor 40 and a voltage feedback point 50.

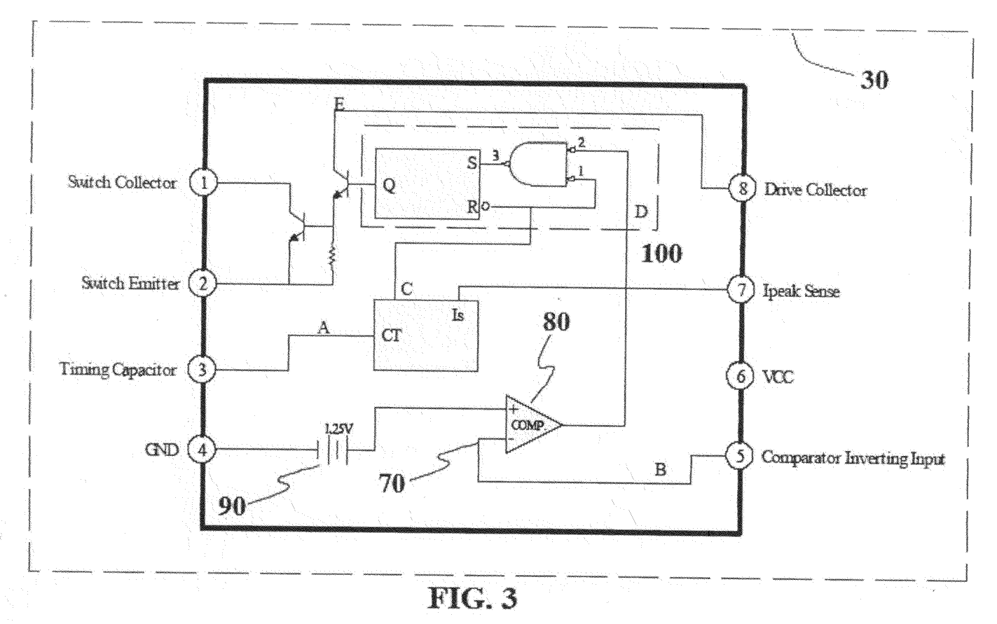

In this preferred embodiment, the DC-DC conversion IC 30 can be selected from regular marketing products having similar functions, such as model MC34063, GL2576 etc., and a negative pole of output voltage is connected to the current detection resistor 40 and then to a system ground. When supplying current is raised and flowing through the DC-DC conversion IC 30 and the current detection resistor 40, voltages of two ends of the current detection resistor 40 are stepped up accordingly, so as to step up a voltage level of a IC ground 60 and therefore voltage drop is produced, further referring to FIG. 3 showing an internal circuit of the DC-DC conversion IC, that is, a voltage level of a set point 70 for setting the output voltage is lower than a reference voltage 90 being stepped up then, thereby the output voltage has been adjusted after a process that an appropriate value is computed by an operational amplifier 80 in the DC-DC conversion IC 30 and is transmitted to a Pulse Width Modulation (PWM) controlling loop 100, and therefore achieve a purpose of voltage compensation.

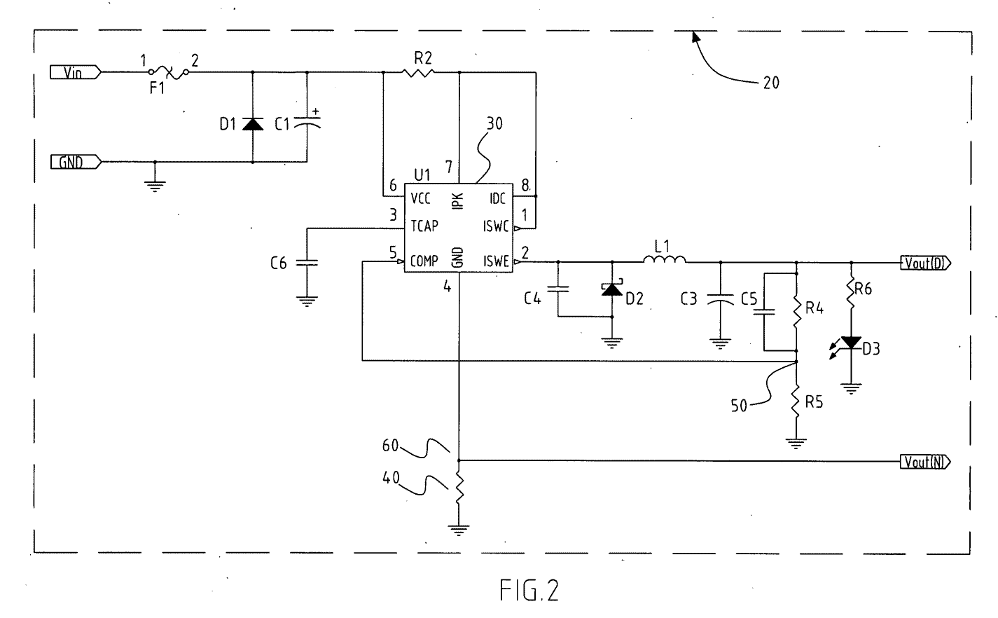

Referring to FIG. 2 illustrating a second embodiment of the present invention, in the second embodiment, the apparatus for compensating output voltage is applied in a step-down transforming circuit 20, and also includes the DC-DC conversion IC 30, the current detection resistor 40 and the voltage feedback point 50, wherein the output voltage of the step-down transforming circuit 20 is able to be adjusted by the same processes as that described above in the first embodiment, and the difference between the first and second embodiments is that the apparatus in the second embodiment conducts a step-down operation.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An apparatus for compensating output voltage, comprising: a DC-DC conversion IC, a step-up transforming circuit, a current detection resistor and a voltage feedback point, wherein in the step-up transforming circuit, the current detection resistor is connected in series to a ground end of the DC-DC conversion IC, and voltage drop is produced as supplying current flows through the current detection resistor, thereby utilizing the voltage drop to step up a reference voltage within the DC-DC conversion IC so that the DC-DC conversion IC can regulate output voltage of the step-up transforming circuit for a purpose of voltage compensation.

2. The apparatus for compensating output voltage as claimed in claim 1, wherein capacity of the current detection resistor is adjustable based on detected signals of the voltage drop in order to be compatible with various products of different output voltages, wires, and types of connectors.

3. The apparatus for compensating output voltage as claimed in claim 1, wherein the DC-DC conversion IC can be a marketing product as model 34063 or similar type of IC which of a reference voltage at 1.25V.

4. The apparatus for compensating output voltage as claimed in claim 1, wherein the DC-DC conversion IC includes an operational amplifier and a Pulse Width Modulation (PWM) controlling loop for modulating output voltage of the step-up transforming circuit.

5. An apparatus for compensating output voltage, comprising: a DC-DC conversion IC, a step-down transforming circuit, a current detection resistor and a voltage feedback point, wherein in the step-down transforming circuit, the current detection resistor is connected in series to a ground end of the DC-DC conversion IC, and voltage drop is produced as supplying current flows through the current detection resistor, thereby utilizing the voltage drop to step up a reference voltage within the DC-DC conversion IC so that the DC-DC conversion IC can regulate output voltage of the step-down transforming circuit for a purpose of voltage compensation.

6. The apparatus for compensating output voltage as claimed in claim 5, wherein capacity of the current detection resistor is adjustable based on detected signals of the voltage drop in order to be compatible with various products of different output voltages, wires, and types of connectors.

7. The apparatus for compensating output voltage as claimed in claim 5, wherein the DC-DC conversion IC can be a marketing product as model 34063 or similar type of IC which of a reference voltage at 1.25V.

8. The apparatus for compensating output voltage as claimed in claim 1, wherein the DC-DC conversion IC includes an operational amplifier and a Pulse Width Modulation (PWM) controlling loop for modulating output voltage of the step-down transforming circuit.
